(19) United States
(12) Patent Application Publication
(10) Pub. No.: US 2026/0105298 A1
(43) Pub. Date: Apr. 16, 2026

(54) SYSTEMS AND METHODS FOR ASYNCHRONOUS REAL-TIME AGENTS

(71) Applicant: Salesforce, Inc., San Francisco, CA (US)

(72) Inventors: Antonio Ginart, Palo Alto, CA (US); Caiming Xiong, Menlo Park, CA (US); Jason Lee, San Francisco, CA (US); John Emmons, San Francisco, CA (US); Naveen Kodali, Palo Alto, CA (US); Silvio Savarese, Palo Alto, CA (US)

(21) Appl. No.: 19/222,690

(22) Filed: May 29, 2025

Related U.S. Application Data
(60) Provisional application No. 63/706,415, filed on Oct. 11, 2024.

(51) Int. Cl. G06N 3/08; G06F 9/50

(52) U.S. Cl. CPC G06N 3/08; G06F 9/5027

(57) ABSTRACT

Embodiments described herein provide a method for asynchronously scheduling output generations for an artificial intelligence (AI) agent. The method includes the AI agent maintaining a ledger to record a sequence of events received from the environment or user, and asynchronously generating responses to these events using a neural network model. The AI agent generates output tokens sequentially and, based on the priority level of a particular event, may halt the current generation process to address higher-priority events. When such an event occurs, the agent initiates a new generation process in response, enabling real-time, prioritized handling of multiple concurrent tasks.

### CROSS REFERENCE(S)

The instant application is a nonprovisional of and claims priority under 35 U.S.C. 119 to U.S. provisional application no. 63/706,415, filed Oct. 11, 2024, which is hereby expressly incorporated by reference herein in its entirety.

### TECHNICAL FIELD

The embodiments relate generally to machine learning systems for AI agents, and more specifically to systems and methods for asynchronous real-time agents.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task. However, current AI systems operate in a rigid, turn-based manner, lacking an understanding of time, which forces user queries and tool-use to occur sequentially. This synchronous design prevents the AI system from multitasking and reduces interactivity, leading to perceived delays and a less efficient user experience.

### BRIEF DESCRIPTION OF THE DRAWINGS

FIG. 1 shows an example operation of an LLM based AI agent, according to some embodiments.

FIG. 2 illustrates a simplified diagram of the asynchronous agent framework, according to some embodiments.

FIG. 3 illustrates a simplified diagram of the asynchronous agent framework, according to some embodiments.

FIG. 4 is an algorithm for handling events, according to some embodiments.

FIGS. 5A-6 illustrate examples of messages that flow through the asynchronous agent framework, according to some embodiments.

FIG. 7 illustrates an exemplary priority table, according to some embodiments

FIG. 8A is a simplified diagram illustrating a computing device implementing the asynchronous real-time agent framework described in FIGS. 1-7, according to some embodiments.

FIG. 8B is a simplified diagram illustrating a neural network structure, according to some embodiments.

FIG. 9 is a simplified block diagram of a networked system suitable for implementing the asynchronous real-time agent framework described in FIGS. 1-8B and other embodiments described herein.

FIG. 10 is an example logic flow diagram illustrating a method of asynchronous scheduling of output generations for an artificial intelligence (AI) agent based on the framework shown in FIGS. 1-9, according to some embodiments.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

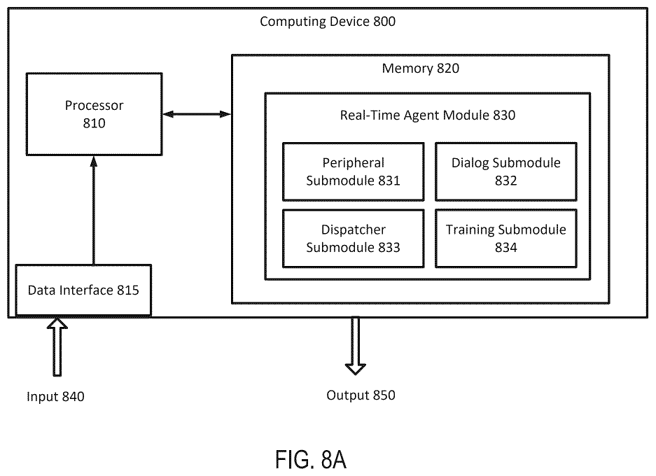

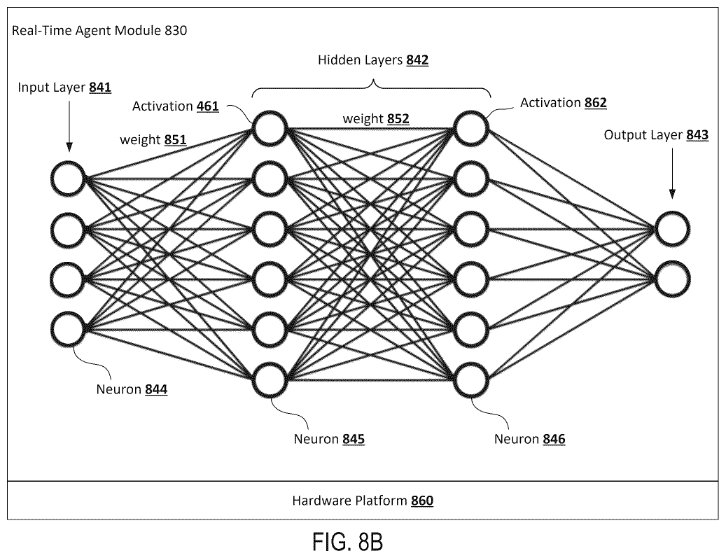

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 8B.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

Current AI systems operate in a rigid, turn-based manner, lacking an understanding of time, which forces user queries and tool-use to occur sequentially. This synchronous design prevents the AI system from multitasking and reduces interactivity, leading to perceived delays and a less efficient user experience. There is a need for AI agents that can manage multiple concurrent processes in real-time, allowing for more fluid and responsive interactions.

Embodiments described herein address the limitations of current AI systems by introducing asynchronous AI agents capable of real-time tool usage and parallel processing. These agents operate within an event-driven finite-state machine architecture, which allows them to manage multiple concurrent processes and respond to user inputs as soon as any process finishes. This design significantly reduces perceived delays and enhances user experience by enabling more fluid and responsive interactions. By interrupting ongoing generations, computation resources (e.g., processor time, memory, and power are conserved by stopping processes that are not necessary to complete.

In some embodiments, the system uses a ledger to log every event that occurs, including internal system messages, tool calls, time stamps, and the time and order in which events happened. When a user communicates with the agent, the communication is added to the ledger accordingly. Periodic clock events may be added to the ledger to provide the system with a sense of time. This comprehensive logging ensures that the AI agent maintains an accurate and up-to-date record of all activities and interactions.

The system employs a “dispatch” language model (LM) that is provided with the contents (or summary of the contents) of the ledger whenever it updates. If the dispatch LM is in the middle of generating an output when an update occurs, the generation process may be interrupted based on the priority level of the new event. A state machine may be employed for keeping track of the state and handling interrupts. For instance, a user speaking may be assigned a high priority that interrupts the dispatch LM, while a clock event may have a low priority and not cause an interruption. This prioritization ensures that critical events are addressed promptly, while less urgent events do not disrupt ongoing processes. Events can be produced by various sources, including the speech-to-text (STT) input peripheral, the dispatcher, the text-to-speech (TTS) output peripheral, and the function caller. The system ensures that state transitions occur smoothly and that the AI agent's state accurately reflects the overall system status.

Outputs generated by the dispatch LM can be used to call various tools or be provided as text to the user. In the case of spoken communication, the output may be sent to a text-to-speech model to generate speech. This modular approach allows the system to integrate with different peripherals, such as automatic speech recognition and text-to-speech, to facilitate real-time voice interactions.

In addition to handling user interactions and tool calls, the system supports parallel thought processes through fork and spawn semantics. A fork call initializes a child process with a copy of the parent's ledger, while a spawn call starts a new process with a fresh ledger. These parallel processes allow the AI agent to manage complex tasks more efficiently by delegating subtasks to child processes.

Overall, the described embodiments provide a robust framework for creating AI agents capable of asynchronous, real-time interactions. By leveraging advanced language models and a well-structured event-driven architecture, these agents can deliver more efficient and responsive user experiences across various applications.

Embodiments described herein provide a number of benefits. For example, by implementing an asynchronous, event-driven architecture with a prioritized ledger of events, the system enables AI agents to process multiple user requests and tool calls in real time, significantly reducing perceived latency and improving the responsiveness of interactive applications. In another example, the use of a finite-state machine and priority-based interruption of language model output generation allows the system to dynamically allocate computational resources to the most critical tasks, ensuring that urgent user inputs or tool results are handled immediately, which enhances the efficiency and reliability of the agent's operation. In another example, the modular integration of peripherals such as automatic speech recognition and text-to-speech enables seamless real-time voice interactions, further expanding the technical capabilities of AI agents in multimodal environments. In another example, the support for parallel thought processes through fork and spawn semantics allows the system to manage complex, multi-step tasks by delegating subtasks to concurrent processes, thereby improving throughput and scalability. In another example, the architecture's ability to maintain a comprehensive, timestamped ledger of all events and system states ensures robust context management and accurate state tracking, which is essential for reliable asynchronous execution. Therefore, with improved performance on real-time, asynchronous AI agent interactions, neural network technology in AI agents is improved.

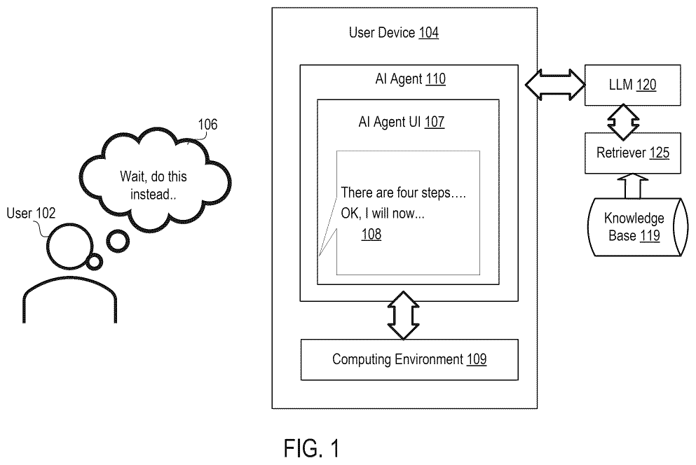

FIG. 1 shows an example operation of an LLM based AI agent, according to embodiments of the present disclosure. An LLM-based AI agent 110 may be implemented on a user device 104 to receive a user task request 106 as a natural language input, typically through a chat or command interface 107. This request 106 may range from simple queries to more complex tasks like data analysis, automation, or even generating content. For example, the user 102 may ask the AI agent 110 to perform an action, but then before the AI agent 110 is able to complete the action (e.g., generating and emitting a full response), user 102 may utter “wait, do this instead”106 which may interrupt AI agent 110.

In one embodiment, the AI agent 110 may process the task request 106 at an LLM 120 to understand its intent, extracting key information such as the task type, desired outcome, and any specific constraints in order to generate a response. The LLM 120 may be hosted at an external server, a cloud service, and/or the like that is accessible by a communication network. In a different implementation, the LLM 120 may be hosted on the user device 104. An input to the LLM 120 may comprise the task request 106 and instruction provided to the LLM 120 to guide its behavior or responses in a particular way, referred to as a “system prompt.” For example, the system prompt may contain instruction for the LLM 120 to analyze the input and respond according to the request identified in the input, and generate an output in a certain format, e.g., suggested code program, text description, etc. The LLM 120 may in turn generate a response 108 based on an input combining the task request 106 and any system prompt together with the remaining contents of the ledger. The LLM 120 may operate with a retriever model 125, which retrieves relevant context documents from a knowledge base 119 as a context, to in turn generate a textual response 108 based on an input combining the task request 106, any system prompt and the retrieved context. Additional details on the LLM 120 generating output tokens to form the response 108 may be described in FIG. 8B.

The response 108 may include instructions, explanations, code scripts or direct actions to address the task request 106. Such response 108 may be displayed via the AI agent interface 107 for transparency. In addition to the response 108 that describes how to fulfill the task request, the LLM 120 may generate computer-executable commands (e.g., system-level commands, Python scripts, etc.) that can directly trigger actions and/or interactions with the computing environment 109 on the user device 104.

For example, when the user 102 requests to block traffic from a specific IP address, the LLM 120 may output a code script to execute on the user device 104 to block the corresponding network traffic, and/or interface with APIs of other applications to perform the requested action, and/or the like. For example, AI agent 110 may generate a script that is executed to send a system commend to a network device such as a router to change a configuration setting to block the specified IP address.

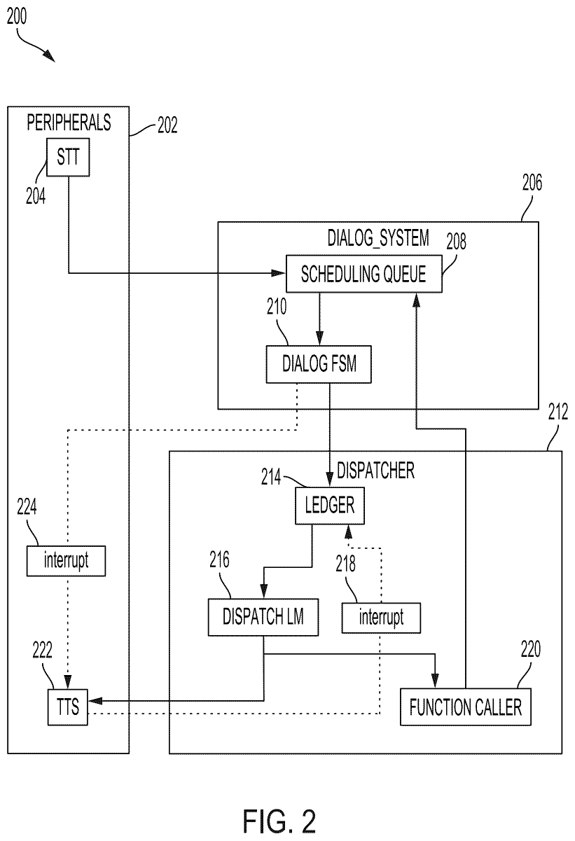

In this way, the LLM-based AI agent may facilitate end-to-end workflow to automate the task request 106. Additional details of the AI agent 110 are described with respect to FIGS. 2-10.

FIG. 2 illustrates a simplified diagram of the asynchronous agent framework 200. In some embodiments, framework 200 is designed to enable real-time, event-driven interactions between an AI agent (e.g., AI agent 110) and a user, supporting asynchronous tool usage, multitasking, and robust handling of user interruptions. Framework 200 is composed of several interconnected modules, each responsible for a distinct aspect of the agent's operation, and is structured to facilitate the asynchronous scheduling and processing of events.

Framework 200 includes peripherals 202, which serve as the primary interface between the user and the agent. In the illustrated example, peripherals 202 encompass both speech-to-text (STT) 204 and text-to-speech (TTS) 222 components. The STT 204 transcribes spoken user input into text, while the TTS 222 converts the agent's textual responses back into audio for the user. These peripherals 202 enable seamless, real-time voice interactions and are designed to support low-latency communication. In some embodiments, additional or different peripherals may be utilized including a text interface, network interface, visual display, etc.

Dialog system 206 orchestrates the flow of events and manages the agent's state. The dialog system 206 is composed of a scheduling queue 208 and a dialog finite-state machine (FSM) 210. The scheduling queue 208 is responsible for prioritizing and queuing events according to their urgency or importance such as user inputs, tool responses, and system notifications. The dialog FSM 210 governs the transitions between different operational states (for example, idle, listening, generating, and emitting), ensuring that the agent responds appropriately to incoming events and user actions.

The dispatcher 212 is another key component of framework 200, responsible for the core reasoning and decision-making processes of the agent. Dispatcher 212 includes the ledger 214, the dispatch language model (dispatch LM) 216, and the function caller 220. The ledger 214 acts as a comprehensive, timestamped record of all events and messages, maintaining the agent's context and supporting accurate replay of the interaction history. The dispatch LM 216 generates responses, manages tool calls, and interprets the current context, while the function caller 220 executes tool operations and returns results asynchronously. This modular structure allows for flexible integration of different language models or toolsets, depending on the requirements of a particular deployment.

Framework 200 is specifically designed to handle interruptions and preemptions, which are essential for real-time, interactive AI agents. For example, an interrupt 224 can be triggered from the dialog FSM 210 to the TTS 222, allowing the system to halt ongoing speech output if the user begins speaking or if a higher-priority event occurs. Similarly, an interrupt 218 can be sent from the TTS 222 to the ledger 214, ensuring that the ledger accurately reflects what has been communicated to the user, even in the presence of interruptions or partial outputs. These interrupt mechanisms are critical for maintaining a responsive and natural user experience, as they allow the agent to adapt dynamically to changing circumstances and user behavior.

In some embodiments, the components of framework 200 are modular and can be replaced or extended as needed. For example, different STT 204 or TTS 222 services may be integrated to optimize for latency, quality, or language support, and the set of tools accessible via function caller 220 can be expanded to support additional functionalities. The event-driven, asynchronous architecture of framework 200, combined with its prioritized scheduling and robust context management, provides a foundation for building highly capable, real-time AI agents that can manage multiple concurrent tasks, handle user interruptions gracefully, and deliver a seamless interactive experience.

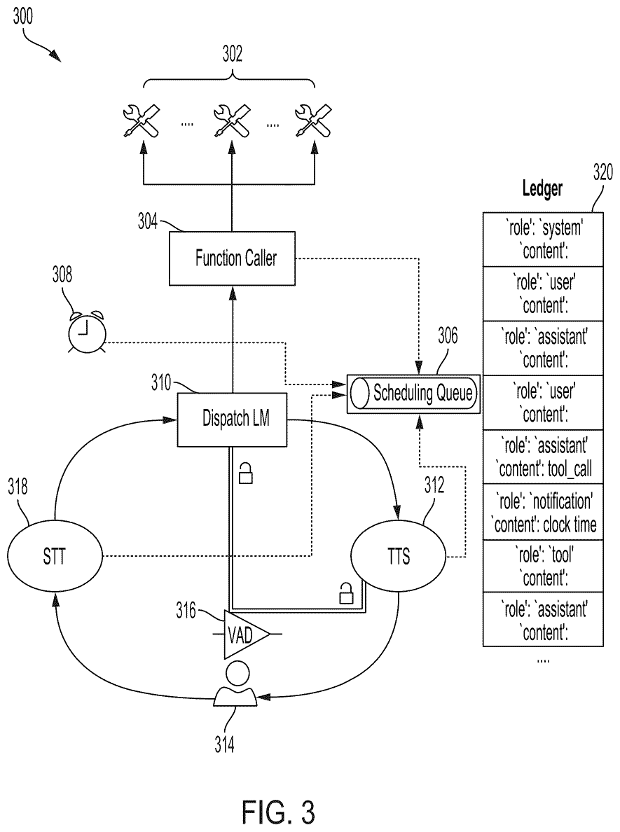

FIG. 3 illustrates a simplified diagram of the asynchronous agent framework 300. In some embodiments, framework 300 is implemented using components of framework 200 described in FIG. 2. Speech from user 314 is received via speech-to-text (STT) 318, which transcribes the audio input and provides the resulting text to the dispatch language model (dispatch LM) 310. The STT 318 is supported by a voice activity detector (VAD) 316, which monitors the audio stream to detect when the user 314 begins or ends speaking, ensuring accurate state transitions and minimizing latency in user-agent interactions.

Within framework 300, the dispatch LM 310 serves as the core decision-making component, responsible for generating assistant responses, managing tool calls, and maintaining context. The dispatch LM 310 interacts with a set of tools 302, which may include APIs, external databases, or other computational resources. When a tool call is required, the dispatch LM 310 issues a request to the function caller 304, which executes the tool operation and returns the result asynchronously. The function caller 304 is capable of handling multiple concurrent tool requests, allowing the agent to process several tasks in parallel.

A key feature of framework 300 is the scheduling queue 306, which implements a priority-based event management system. Events such as user input (e.g., STT 318), tool responses (e.g., via function caller 304), and system notifications (e.g., time updates from clock 308 or emitting status of TTS 312) are enqueued with associated priority levels, ensuring that urgent or time-sensitive events are processed ahead of less critical ones. The scheduling queue 306 is managed by an event-driven finite-state machine, which transitions between states such as idle, listening, generating, and emitting, based on the current activity and incoming events. For example, if user 314 interrupts the agent while it is generating output, the scheduling queue 306 can preempt the current process and immediately handle the new user input.

The framework 300 also incorporates a clock 308, which provides periodic timestamped messages to the system, enabling clock awareness within the dispatch LM 310. This allows the agent to reason about time, manage deadlines, and coordinate long-running or time-constrained tasks. The clock 308 can be configured to send updates at regular intervals, such as every five seconds, and these updates are recorded in the ledger 320.

The ledger 320 is a comprehensive, timestamped record of all events, messages, and state transitions within framework 300. It serves as the single source of truth for the agent's context, ensuring robust context management and accurate replay of the interaction history. The dispatch LM 310 reads from and appends to the ledger 320 as it processes events, generates responses, and issues tool calls.

When the dispatch LM 310 generates a response, the output may be streamed to the user 314 via text-to-speech (TTS) 312. The TTS 312 converts the generated text into audio, enabling seamless real-time voice interactions. In some embodiments, the TTS 312 processes the output sentence-by-sentence, allowing for low-latency feedback and the ability to handle user interruptions promptly. If user 314 begins speaking while the TTS 312 is emitting, the VAD 316 detects the interruption, and the scheduling queue 306 ensures that the system transitions to the appropriate state to handle the new input. Scheduling queue 306 may be treated as a ranked list of scheduled actions. As new actions are added to the scheduled queue, they may be added in an order different than the order in which they are added. For example, an action with a higher priority may be scheduled to occur before an action that was previously scheduled.

Framework 300 supports advanced features such as parallel thought processes, where the dispatch LM 310 can fork or spawn new concurrent processes to handle subtasks. For example, a fork operation initializes a new process with a copy of the parent's ledger 320, while a spawn operation starts with a fresh ledger and specific instructions. These capabilities allow the agent to manage complex, multi-step tasks and dynamically organize multi-agent hierarchies at runtime.

In some embodiments, a parallel thought process is a concurrent instance of the asynchronous execution environment with parent-child semantics. The child's input stream is populated by function calls from the parent, and the child's output stream provides function responses to the parent. Parallel thought processes are created via either fork or spawn calls, which are considered special reserved tools.

For a fork call, the parent initializes the child's ledger with a copy of its own and appends a new message containing further instructions for the child. For a spawn call, the parent initializes the child with a new ledger and populates the first message containing the child's instructions. The parent thought process determines whether a fork or a spawn call is more appropriate on a case-by-case basis, given the clear trade-offs for each type of parallel thought process. Forking uses more context in the child and therefore may be more expensive, while also potentially including unnecessary or distracting messages; thus, it should only be used if the child requires a full view into the parent's context to achieve its goal. By default, spawning is preferable in most cases, since the parent can usually summarize the relevant details into the child's instructions.

The dispatch language model (LM) may be the same as the parent by default, but the parent can prescribe a different dispatch LM, provided it is fine-tuned or prompted to correctly handle the prompt template as expected by the environment. For both fork and spawn, a third reserved tool, kill, is available for the dispatching LM to interrupt and terminate a parallel thought process. As implied by these function call semantics, recursive creation of parallel thought processes is possible, enabling dynamic organization of multi-agent hierarchies at runtime.

In some embodiments, the components of framework 300 are modular and can be replaced or extended as needed. For example, different STT 318 or TTS 312 services may be used depending on latency and quality requirements, and the set of tools 302 can be expanded to support additional functionalities. Tools 302 may include, for example, web search, calendar integration, email management, data analysis, document summarization, translation tools, database querying, image recognition, and the like.

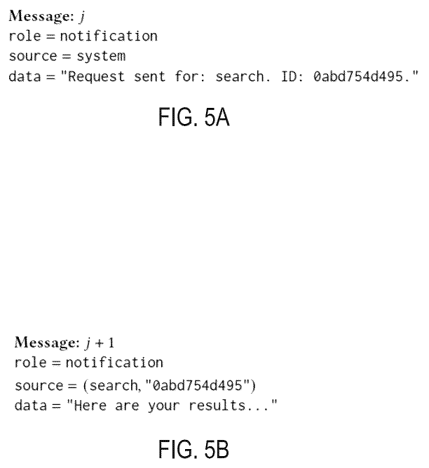

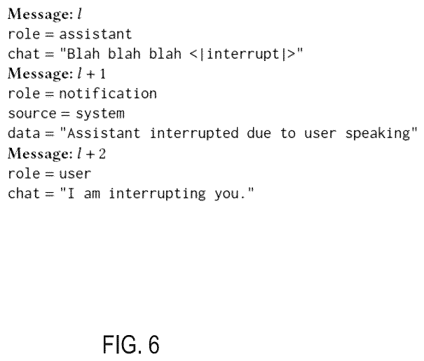

As illustrated in the exemplary ledger 320, each entry in the ledger may identify the role of the source of the entry in the ledger (e.g., system, user, assistant, notification, or tool). In addition to the role, the entry may identify the specific content, for example the result of a tool call, text converted from user speech, clock time, and the like. Example ledger entries (i.e., messages) are illustrated in FIGS. 5A-6.

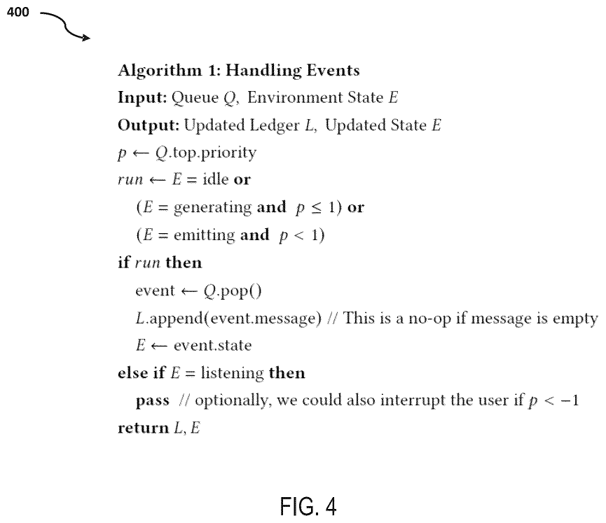

FIG. 4 is an algorithm for handling events, according to some embodiments. This algorithm, referred to as Algorithm 1, outlines a process by which the asynchronous agent framework 200 may manage and process events in real-time, ensuring that the AI agent responds promptly and appropriately to various inputs and system changes.

The algorithm begins by retrieving the top-priority event from the scheduling queue (e.g., 208 or 306). The priority of the event is stored in the variable p. The algorithm then checks whether the system is in a state that allows the event to be processed. Specifically, the event can be processed if the system is idle, if it is generating and the event's priority is less than or equal to 1, or if it is emitting and the event's priority is less than 1. This ensures that high-priority events can interrupt lower-priority tasks, maintaining the responsiveness of the agent.

If the conditions for processing the event are met, the algorithm proceeds to pop the event from the scheduling queue (e.g., 208 or 306). The event's message, if any, is appended to the ledger (e.g., 214 or 320) and the state is updated according to the event. The ledger maintains a comprehensive record of all events and messages, ensuring that the agent's context is accurately tracked. The system's state is then updated to reflect the new state specified by the event.

If the system is in the listening state, the algorithm does not process the event immediately but instead allows the user to continue speaking. This is crucial for maintaining a natural and uninterrupted user experience. However, if the event's priority is less than −1, the system may choose to interrupt the user, depending on the specific implementation and configuration. The end results of the algorithm is to take an input queue and state, and return an updated state and ledger.

An event contains a priority level and may cause a state transition to occur. Some events also include messages to be appended to the ledger. Events can be produced by the STT (or input peripheral) when the user begins or finishes speaking, by the dispatcher when the dispatch language model begins or finishes generation, by the TTS (or output peripheral) when the output stream begins or finishes emitting, and by the function caller when a tool-use request is sent or a response is received. To ensure that the dialog FSM state variable accurately reflects the overall system, state transitions initiated by the dispatcher and the peripherals may have the minimum possible priority, −∞, so they are processed instantly.

Alternatively, the dispatcher and peripherals may use a locking mechanism to atomically update the state variable when appropriate, effectively bypassing the scheduling queue. In contrast, function call responses may not use such a priority; instead, they should use a developer-defined priority and always be processed through the scheduling queue. Events are pushed to the scheduling queue based on internal processing or state changes. For example, the execution environment must ensure that the TTS is halted if an interrupt event is pushed by the STT subsystem because the user has started to speak.

Overall, Algorithm 1 provides a robust and flexible mechanism for managing events in the asynchronous agent framework 200. By prioritizing events, maintaining an accurate ledger, and handling interruptions gracefully, the algorithm ensures that the AI agent can deliver a responsive and seamless interactive experience, even in complex, real-time environments. Algorithm 1 may be implemented, for example, by a dialog system 206.

FIGS. 5A, 5B, and 6 illustrate specific examples of messages that flow through the asynchronous agent framework, each highlighting different aspects of the message structure and event handling described in the system architecture. These figures build upon the foundational components and processes introduced in FIGS. 2-4, particularly the ledger, the dialog finite state machine (FSM), and the event-driven scheduling queue.

FIG. 5A presents message j, which is a notification message generated when a function call is initiated by the agent. In this message, the role is set to “notification,” indicating that the message is not a direct user or assistant utterance but rather a system-generated update. The source field specifies the origin of the notification, such as the system or a particular tool, and may include metadata like the tool name and a unique request ID. The data field contains a textual description of the event, for example, “Request sent for: search. ID: 0abd754d495.” This message is appended to the ledger as soon as the function call is dispatched, ensuring that the system maintains an accurate and timestamped record of all tool-use requests. This process is closely tied to the event handling described in FIG. 4, where such notifications are queued and processed according to their priority, updating the system state and context as needed.

FIG. 5B shows message j+1, which is another notification message, this time generated upon the completion of the function call initiated in message j. The role remains “notification,” but the source now includes both the tool name and the specific request ID, allowing the system to correlate the response with the original request. The data field in this message contains the results of the function call, such as “Here are your results . . . ,” providing the output retrieved from the tool. This message is also appended to the ledger, updating the agent's context and enabling the dispatcher to generate appropriate follow-up actions or responses. The handling of this message demonstrates the asynchronous nature of the system, as the response can arrive and be processed independently of other ongoing events, in line with the event-driven FSM and scheduling queue mechanisms described in FIGS. 2-4.

FIG. 6 illustrates a sequence of three messages—l, l+1, and l+2—that exemplify the system's approach to handling interruptions during ongoing interactions. Message l is an assistant message (e.g., a message generated by the dispatch LM) with the role set to “assistant” and a chat field containing the assistant's output, such as “Blah blah blah <|interrupt|>.” The presence of the special interruption token signals that the assistant's output was interrupted, typically because the user began speaking. Message l+1 is a notification message generated by the system, with the source indicating the system and the data field stating “Assistant interrupted due to user speaking.” This message is posted to the ledger immediately when the interruption is detected, ensuring that the system's state and context accurately reflect the interruption event. Message l+2 is a user message, with the role set to “user” and the chat field containing the user's new input, such as “I am interrupting you.” This sequence of messages demonstrates how the system reconciles the output streams between the assistant and the user, ensuring that only the portion of the assistant's output that was actually emitted before the interruption is recorded in the ledger. This approach maintains the integrity of the conversation history and allows the FSM to transition smoothly between emitting, listening, and generating states, as described in the earlier figures. Note that there may be a delay between generating text, and it being spoken via the TTS. In this case, the environment is responsible for reconciliation between these two streams and should only update the ledger to reflect the actual output emitted to the user.

Together, these figures illustrate the detailed structure and flow of messages within the asynchronous agent framework. The use of distinct roles—such as assistant, user, and notification—along with fields like source, chat, and data, enables the system to manage complex, real-time interactions with precise context tracking and robust event handling.

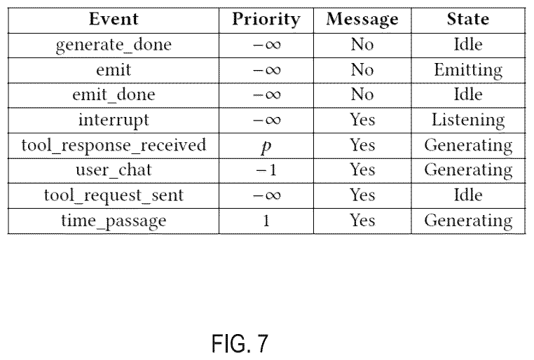

In some embodiments, token generation and TTS emitting happen concurrently, and it is technically possible for TTS emitting to finish before the generation of the assistant message. For example, in the case in which an assistant message begins with a chat and then includes a thought. While the message as an abstract data type is a dictionary, when implemented, it streams in serially and is processed in real-time as a stream. If a chat streams in, the TTS system will start emitting sentence-by-sentence, meaning the TTS will run in a delay, but it is possible that the TTS could finish emitting the chat before the LLM generation finishes the subsequent thought. The details of this edge case are omitted in FIG. 7, but it is important to handle this case because the dialog FSM state should revert back to generating rather than transition to idle in such a situation.

FIG. 7 illustrates an exemplary priority table, according to some embodiments. The various events are shown with their associated priority levels, whether they contain a message to be appended to the ledger, and the resulting state transitions of the finite state machine (FSM). The table serves as a central reference for how the system schedules and processes events, ensuring that the agent responds to real-time interactions in a fluid and contextually appropriate manner. The priorities, message status, and other elements of the table may be user-configurable to adapt the agent for different applications. For example, specific tools may be assigned different priorities p depending on the specific tool and use-case.

Each row in the table represents a distinct event type that the system may encounter. The “generate_done” event, for example, is assigned the minimum possible priority (−∞), does not contain a message, and transitions the FSM to the idle state. This event signals the completion of a generation process by the language model, allowing the system to reset and await further input or actions. The “emit” event, also with priority −∞ and no message, transitions the FSM into the emitting state, indicating that the system is actively outputting a response, such as streaming text-to-speech to the user. Similarly, “emit_done” marks the completion of this output process, returning the FSM to the idle state.

The “interrupt” event, which also carries the minimum priority and does contain a message, transitions the FSM to the listening state. This event is triggered when the user begins speaking, interrupting any ongoing output from the assistant. The presence of a message ensures that the ledger accurately records the interruption, maintaining a faithful history of the interaction. The “tool_response_received” event in the illustrated example has a priority (denoted as p) that is variable and tool-specific, and contains a message. This event transitions the FSM to the generating state, reflecting the arrival of a tool's response and prompting the agent to process the new information and potentially generate a follow-up action or reply.

The “user_chat” event, with a priority of −1 and a message, also leads the FSM into the generating state. This event captures direct user input, ensuring that user utterances are promptly processed and integrated into the ongoing conversation. The “tool_request_sent” event, like several others, has a priority of −∞, contains a message, and transitions the FSM to the idle state. This event records the dispatch of a tool-use request, ensuring that the system's context and ledger are updated as soon as the request is made.

Finally, the “time_passage” event, with a priority of 1 and a message, transitions the FSM to the generating state. This event is periodically queued by the system to provide clock updates, enabling the agent to maintain awareness of elapsed time and coordinate time-sensitive tasks or reasoning processes.

At a higher level, this priority table operationalizes the event-driven scheduling described in the architecture figures, such as the FSM and scheduling queue in FIGS. 2-4. It directly informs the behavior of Algorithm 1, which processes events from the scheduling queue based on their priority and the current FSM state, ensuring that high-priority or interrupt-driven events are handled immediately, while others are queued and processed in order. The assignment of priorities and state transitions allows the system to manage concurrent processes, handle interruptions gracefully, and maintain a responsive and coherent interaction flow.

At any given moment, the FSM exists in one of four states with respect to the execution environment: idle, generating, emitting, or listening. The execution environment is responsible for ensuring that the FSM state accurately reflects the true state of the system.

For instance, when the TTS (Text-to-Speech) component is streaming output (either voice or text) to the user, the FSM is considered to be in the emitting state. If the system is generating tokens but not emitting, the FSM is in the generating state. When the user is in the process of creating input (for example, speaking), the FSM is in the listening state. In all other cases, the FSM is idle.

Interruptions are treated as a first-class feature within the asynchronous agent. Interruptions are explicitly included as part of the proposed instruction set. The scheduling queue enables the environment to enforce atomic updates to the ledger, even in the presence of concurrency. Every 5 seconds, the system queues a time passage notification message.

All messages are assigned a priority. By default, user messages have a priority of −1 and assistant messages have a priority of 1, although these values can be configured on a per-deployment basis.

In some embodiments, a distinction in how interruptions are handled during the generating and emitting states is that, in the event of a tie in priority level, the interrupt occurs if the dispatch language model is generating, but does not occur if it is emitting.

Tool definitions should specify a priority; however, the default priority for request-sent and response-received messages is 1.

### Computer and Network Environment

FIG. 8A is a simplified diagram illustrating a computing device implementing the asynchronous real-time agent framework described in FIGS. 1-7, according to one embodiment described herein. As shown in FIG. 8A, computing device 800 includes a processor 810 coupled to memory 820. Operation of computing device 800 is controlled by processor 810. And although computing device 800 is shown with only one processor 810, it is understood that processor 810 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 800. Computing device 800 may be implemented as a stand-alone subsystem, as a board added to a computing device, and/or as a virtual machine.

Memory 820 may be used to store software executed by computing device 800 and/or one or more data structures used during operation of computing device 800. Memory 820 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 810 and/or memory 820 may be arranged in any suitable physical arrangement. In some embodiments, processor 810 and/or memory 820 may be implemented on a same board, in a same package (e.g., system-in-package), on a same chip (e.g., system-on-chip), and/or the like. In some embodiments, processor 810 and/or memory 820 may include distributed, virtualized, and/or containerized computing resources. Consistent with such embodiments, processor 810 and/or memory 820 may be located in one or more data centers and/or cloud computing facilities.

In another embodiment, processor 810 may comprise multiple microprocessors and/or memory 820 may comprise multiple registers and/or other memory elements such that processor 810 and/or memory 820 may be arranged in the form of a hardware-based neural network, as further described in FIG. 8B.

In some examples, memory 820 may include non-transitory, tangible, machine readable media that includes executable code that when run by one or more processors (e.g., processor 810) may cause the one or more processors to perform the methods described in further detail herein. For example, as shown, memory 820 includes instructions for real-time agent module 830 that may be used to implement and/or emulate the systems and models, and/or to implement any of the methods described further herein. real-time agent module 830 may receive input 840 such as an input training data (e.g., queries and responses, including asynchronous-type data) via the data interface 815 and generate an output 850 which may be a text response.

The data interface 815 may comprise a communication interface, a user interface (such as a voice input interface, a graphical user interface, and/or the like). For example, the computing device 800 may receive the input 840 (such as a training dataset) from a networked database via a communication interface. Or the computing device 800 may receive the input 840, such as a user prompt, from a user via the user interface.

In some embodiments, the real-time agent module 830 is configured to generate responses to prompts in the asynchronous manner described herein. The real-time agent module 830 may further include peripheral submodule 831 (e.g., similar to peripherals 202) configured to control peripherals such as TTS and STT for user interaction as described herein. The real-time agent module 830 may further include dialog submodule 832 (e.g., similar to dialog system 206) configured to orchestrate the flow of events and manages the agent's state as described herein. The real-time agent module 830 may further include dispatcher submodule 833 (e.g., similar to dispatcher 212) configured to perform the core reasoning and decision-making processes as described herein. The real-time agent module 830 may further include training submodule 834 configured to train components of real-time agent module 830 (e.g., dispatch LM) as described herein.

Some examples of computing devices, such as computing device 800 may include non-transitory, tangible, machine readable media that include executable code that when run by one or more processors (e.g., processor 810) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 8B is a simplified diagram illustrating the neural network structure implementing the real-time agent module 830 described in FIG. 8A, according to some embodiments. In some embodiments, the real-time agent module 830 and/or one or more of its submodules 831-834 may be implemented at least partially via an artificial neural network structure shown in FIG. 8B. The neural network comprises a computing system that is built on a collection of connected units or nodes, referred to as neurons (e.g., 844, 845, 846). Neurons are often connected by edges, and an adjustable weight (e.g., 851, 852) is often associated with the edge. The neurons are often aggregated into layers such that different layers may perform different transformations on the respective input and output transformed input data onto the next layer.

For example, the neural network architecture may comprise an input layer 841, one or more hidden layers 842 and an output layer 843. Each layer may comprise a plurality of neurons, and neurons between layers are interconnected according to a specific topology of the neural network topology. The input layer 841 receives the input data (e.g., 840 in FIG. 8A), such as a user prompt. The number of nodes (neurons) in the input layer 841 may be determined by the dimensionality of the input data (e.g., the length of a vector of the user prompt). Each node in the input layer represents a feature or attribute of the input.

The hidden layers 842 are intermediate layers between the input and output layers of a neural network. It is noted that two hidden layers 842 are shown in FIG. 8B for illustrative purpose only, and any number of hidden layers may be utilized in a neural network structure. Hidden layers 842 may extract and transform the input data through a series of weighted computations and activation functions.

For example, as discussed in FIG. 8A, the real-time agent module 830 receives an input 840 of a prompt and transforms the input into an output 850 of a generated response. To perform the transformation, each neuron receives input signals, performs a weighted sum of the inputs according to weights assigned to each connection (e.g., 851, 852), and then applies an activation function (e.g., 861, 862, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 841 is transformed into rather different values indicative data characteristics corresponding to a task that the neural network structure has been designed to perform.

The output layer 843 is the final layer of the neural network structure. It produces the network's output or prediction based on the computations performed in the preceding layers (e.g., 841, 842). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the real-time agent module 830 and/or one or more of its submodules 831-834 may comprise the transformative neural network structure of layers of neurons, and weights and activation functions describing the non-linear transformation at each neuron. Such a neural network structure is often implemented on one or more hardware processors 810, such as a graphics processing unit (GPU). An example neural network may be a transformer-based LLM, and/or the like.

In one embodiment, the real-time agent module 830 and its submodules 831-834 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q, K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the real-time agent module 830 and its submodules 831-834 may be implemented by hardware, software and/or a combination thereof. For example, the real-time agent module 830 and its submodules 831-834 may comprise a specific neural network structure implemented and run on various hardware platforms 860, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 860 used to implement the neural network structure is specifically configured based on factors such as the complexity of the neural network, the scale of the tasks (e.g., training time, input data scale, size of training dataset, etc.), and the desired performance.

For example, to deploy the real-time agent module 830 and its submodules 831-834 and/or any other neural network models such as the dispatch LM described herein onto hardware platform 860, the neural network based modules 830 and its submodules 831-834 may be optimized for deployment by converting it to a suitable format, such as ONNX or TensorRT, to improve performance and compatibility. Next, depending on the size and workload requirements for modules 830 and its submodules 831-834, hardware types may be chosen for deployment, e.g., processing capacity, GPU memory size, and/or the like. Frameworks and drivers for the chosen hardware 860 frameworks and drivers may thus be installed, such as PyTorch, TensorFlow, or CUDA, to support the hardware platform 860. Then, weights and parameters of the real-time agent module 830 and its submodules 831-834 may be loaded to the hardware 860. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the real-time agent module 830 and its submodules 831-834 may be deployed as a service, then they may be integrated with an API endpoint, using tools like Flask, FastAPI, or a cloud platform serverless services, and is accessible by a remote user via a network.

In another embodiment, some or all of layers 841, 842, 843 and/or neurons 842, 845, 846, and operations there between such as activations 861, 862, and/or the like, of the real-time agent module 830 and its submodules 831-834 may be realized via one or more ASICs. For example, each neuron 842, 845 and 846 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the real-time agent module 830 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based real-time agent module 830 and one or more of its submodules 831-834 may be trained by iteratively updating the underlying parameters (e.g., weights 851, 852, etc., bias parameters and/or coefficients in the activation functions 861, 862 associated with neurons) of the neural network based on a loss function. For example, during forward propagation, the training data such as asynchronous chat logs are fed into the neural network. The data flows through the network's layers 841, 842, with each layer performing computations based on its weights, biases, and activation functions until the output layer 843 produces the network's output 850. In some embodiments, output layer 843 produces an intermediate output on which the network's output 850 is based.

The output generated by the output layer 843 is compared to the expected output (e.g., a “ground-truth” such as the corresponding response) from the training data, to compute a loss function that measures the discrepancy between the predicted output and the expected output. Given the loss, the negative gradient of the loss function is computed with respect to each weight of each layer individually. Such negative gradient is computed one layer at a time, iteratively backward from the last layer 843 to the input layer 841 of the neural network. These gradients quantify the sensitivity of the network's output to changes in the parameters. The chain rule of calculus is applied to efficiently calculate these gradients by propagating the gradients backward from the output layer 843 to the input layer 841.

In one embodiment, the neural network based real-time agent module 830 and one or more of its submodules 831-834 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning - in other words, backward propagation and forward propagation may occur for both “training” and “inference” stages of the neural network mode.

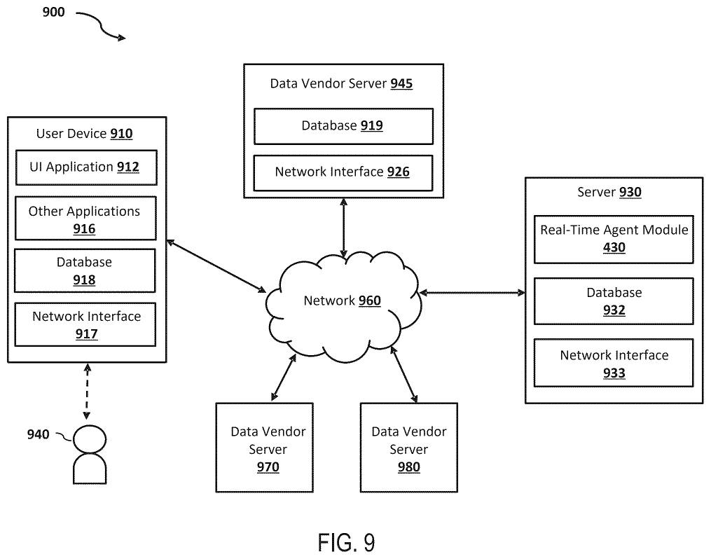

In some embodiments, real-time agent module 830 and its submodules 831-834 may be housed at a centralized server (e.g., computing device 800) or one or more distributed servers. For example, one or more of real-time agent module 830 and its submodules 831-834 may be housed at external server(s). The different modules may be communicatively coupled by building one or more connections through application programming interfaces (APIs) for each respective module. Additional network environment for the distributed servers hosting different modules and/or submodules may be discussed in FIG. 9.

During a backward pass, parameters of the neural network are updated backwardly from the last layer to the input layer (backpropagating) based on the computed negative gradient using an optimization algorithm to minimize the loss. The backpropagation from the last layer 843 to the input layer 841 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen user prompts.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in AI agents.

FIG. 9 is a simplified block diagram of a networked system suitable for implementing the asynchronous real-time agent framework described in FIGS. 1-8B and other embodiments described herein. In one embodiment, system 900 includes the user device 910 which may be operated by user 940, data vendor servers 945, 970 and 980, server 930, and other forms of devices, servers, and/or software components that operate to perform various methodologies in accordance with the described embodiments. Exemplary devices and servers may include device, stand-alone, and enterprise-class servers which may be similar to the computing device 800 described in FIG. 8A, operating an OS such as a MICROSOFT® OS, a UNIX® OS, a LINUX® OS, or other suitable device and/or server-based OS. It can be appreciated that the devices and/or servers illustrated in FIG. 9 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 910, data vendor servers 945, 970 and 980, and the server 930 may communicate with each other over a network 960. User device 910 may be utilized by a user 940 (e.g., a driver, a system admin, etc.) to access the various features available for user device 910, which may include processes and/or applications associated with the server 930 to receive an output data anomaly report.

User device 910, data vendor server 945, and the server 930 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 900, and/or accessible over network 960.

User device 910 may be implemented as a communication device that may utilize appropriate hardware and software configured for wired and/or wireless communication with data vendor server 945 and/or the server 930. For example, in one embodiment, user device 910 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 910 of FIG. 9 contains a user interface (UI) application 912, and/or other applications 916, which may correspond to executable processes, procedures, and/or applications with associated hardware. For example, the user device 910 may receive a message indicating a response from the server 930 and display the message via the UI application 912. In other embodiments, user device 910 may include additional or different modules having specialized hardware and/or software as required.

In one embodiment, UI application 912 may communicatively and interactively generate a UI for an AI agent implemented through the real-time agent module 830 (e.g., an LLM agent) at server 930. In at least one embodiment, a user operating user device 910 may enter a user utterance, e.g., via text or audio input, such as a question, uploading a document, and/or the like via the UI application 912. Such user utterance may be sent to server 930, at which real-time agent module 830 may generate a response via the process described in FIGS. 1-7. The real-time agent module 830 may thus cause a display of a response at UI application 912 and interactively update the display in real time with the user utterance.

In various embodiments, user device 910 includes other applications 916 as may be desired in particular embodiments to provide features to user device 910. For example, other applications 916 may include security applications for implementing client-side security features, programmatic client applications for interfacing with appropriate application programming interfaces (APIs) over network 960, or other types of applications. Other applications 916 may also include communication applications, such as email, texting, voice, social networking, and IM applications that allow a user to send and receive emails, calls, texts, and other notifications through network 960. For example, the other application 916 may be an email or instant messaging application that receives a prediction result message from the server 930. Other applications 916 may include device interfaces and other display modules that may receive input and/or output information. For example, other applications 916 may contain software programs for asset management, executable by a processor, including a graphical user interface (GUI) configured to provide an interface to the user 940 to view responses.

User device 910 may further include database 918 stored in a transitory and/or non-transitory memory of user device 910, which may store various applications and data and be utilized during execution of various modules of user device 910. Database 918 may store user profile relating to the user 940, predictions previously viewed or saved by the user 940, historical data received from the server 930, and/or the like. In some embodiments, database 918 may be local to user device 910. However, in other embodiments, database 918 may be external to user device 910 and accessible by user device 910, including cloud storage systems and/or databases that are accessible over network 960.

User device 910 includes at least one network interface component 917 adapted to communicate with data vendor server 945 and/or the server 930. In various embodiments, network interface component 917 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 945 may correspond to a server that hosts database 919 to provide training datasets including user inputs and system internal thoughts and outputs to the server 930. The database 919 may be implemented by one or more relational database, distributed databases, cloud databases, and/or the like.

The data vendor server 945 includes at least one network interface component 926 adapted to communicate with user device 910 and/or the server 930. In various embodiments, network interface component 926 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 945 may send asset information from the database 919, via the network interface 926, to the server 930.

The server 930 may be housed with the real-time agent module 830 and its submodules described in FIG. 8A. In some implementations, real-time agent module 830 may receive data from database 919 at the data vendor server 945 via the network 960 to generate responses. The generated responses may also be sent to the user device 910 for review by the user 940 via the network 960.

In one embodiment, an AI agent implementing the real-time agent module 830 and its submodules described in FIG. 8A may be built based on an LLM as described in FIG. 8B. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the real-time agent module 830 and its submodules described in FIG. 8A may be implemented as a cloud-based AI agent which may be accessed by user device 910 via a chatbot application, a web application, customer support or SaaS applications. In another implementation, a client-side AI agent component may be delivered from the server 930 to user device 910 for local installation such that the client-side AI agent may be installed and runs directly on the user's device. Such local AI agent on the user device 910 may be available offline to adapt to privacy-sensitive applications. In another implementation, the AI agent implementing the real-time agent module 830 and its submodules described in FIG. 8A may adopt a hybrid cloud and client-based structure to balance computing speed, cost and privacy. For example, a local AI agent may handle basic AI queries locally, but complex queries may be sent to server 930 to process.

The database 932 may be stored in a transitory and/or non-transitory memory of the server 930. In one implementation, the database 932 may store data obtained from the data vendor server 945. In one implementation, the database 932 may store parameters of the real-time agent module 830. In one implementation, the database 932 may store previously generated responses, and the corresponding input feature vectors.

In some embodiments, database 932 may be local to the server 930. However, in other embodiments, database 932 may be external to the server 930 and accessible by the server 930, including cloud storage systems and/or databases that are accessible over network 960.

The server 930 includes at least one network interface component 933 adapted to communicate with user device 910 and/or data vendor servers 945, 970 or 980 over network 960. In various embodiments, network interface component 933 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 960 may be implemented as a single network or a combination of multiple networks. For example, in various embodiments, network 960 may include the Internet or one or more intranets, landline networks, wireless networks, and/or other appropriate types of networks. Thus, network 960 may correspond to small scale communication networks, such as a private or local area network, or a larger scale network, such as a wide area network or the Internet, accessible by the various components of system 900.

### Example Work Flows

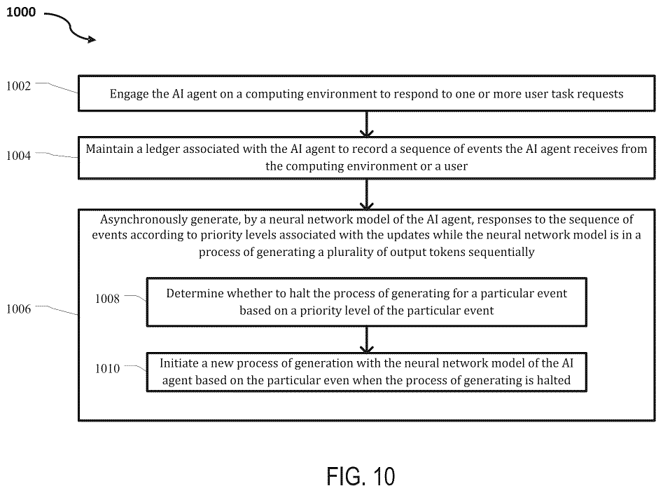

FIG. 10 is an example logic flow diagram illustrating a method of asynchronous scheduling of output generations for an artificial intelligence (AI) agent based on the framework shown in FIGS. 1-9, according to some embodiments. One or more of the processes of method 1000 may be implemented, at least in part, in the form of executable code stored on non-transitory, tangible, machine-readable media that when run by one or more processors may cause the one or more processors to perform one or more of the processes. In some embodiments, method 1000 corresponds to the operation of the real-time agent module 830 (e.g., FIGS. 8A and 9) that performs the asynchronous interactions described herein.

In some embodiments, method 1000 is performed by a system such as computing device 800, user device 910, server 930, or another device or combination of devices. Inputs (e.g. user prompts) may be received via a data interface such as data interface 815, network interface 917, network interface 933, or via a data interface that is integrated with a device. For example UI Application 912 may receive user inputs via a text input interface (e.g., keyboard), audio input (e.g., microphone), video interface (e.g., camera), or other interface for receiving user inputs (e.g., a mouse or touch display).

As illustrated, the method 1000 includes a number of enumerated steps, but aspects of the method 1000 may include additional steps before, after, and in between the enumerated steps. In some aspects, one or more of the enumerated steps may be omitted or performed in a different order.

At step 1002, the system engages the AI agent on a computing environment to respond to one or more user task requests. In some embodiments, the system trains the neural network model of the AI agent on real-time type data including at least one of: out of order messages, time stamps, user queries that include a requested time to finish a task, or ignoring the results of a tool request if the result is obviated based on an updated user utterance. This training helps the AI agent handle various real-time scenarios effectively, ensuring it can manage asynchronous interactions and prioritize tasks based on the context and urgency.

At step 1004, the system maintains a ledger associated with the AI agent to record a sequence of events the AI agent receives from the computing environment or a user. This ledger acts as a comprehensive log of all interactions and events, providing a detailed history that the AI agent can reference (e.g., by inclusion in the context provided to the LLM) to maintain context and continuity in its responses.

At step 1006, the system asynchronously generates, by a neural network model of the AI agent, responses to the sequence of events according to priority levels associated with the sequence of events while the neural network model is in a process of generating a plurality of output tokens sequentially. The generating of responses may be performed via steps 1008 and 1010 as described below.

At step 1008, the system determines whether to halt the process of generating for a particular event based on a priority level of the particular event. In some embodiments, the particular event is a result of a tool request from a tool of a plurality of tools. This means that the AI agent can handle multiple tool requests simultaneously, prioritizing them based on their importance and relevance. In some embodiments, the priority level of the particular event is based on which tool of the plurality of tools is providing the result. This ensures that more critical tools or those with higher priority results are processed first. In some embodiments, the determining whether to halt the process of generating is further based on a current state of a state machine. This allows the AI agent to make informed decisions about whether to interrupt its current task based on its overall state and the priority of the new event.

In some embodiments, state transitions of the state machine are based on at least one of: an initiation of input from an input peripheral, a completion of input from an input peripheral, an initiation of generation with the neural network model, a completion of generation with the neural network model, an initiation of output to an output peripheral, a completion of output to an output peripheral, a tool-use request, or a response to a tool-use request. These state transitions help the AI agent manage its tasks and interactions effectively, ensuring that it can handle multiple processes concurrently and switch between them as needed.

At step 1010, the system initiates a new process of generation with the neural network model of the AI agent based on the particular event when the process of generating is halted. This ensures that high-priority events are addressed promptly, maintaining the responsiveness and efficiency of the AI agent.

In some embodiments, the system inputs all or a subset of the ledger to the neural network model. This allows the AI agent to use the recorded events and interactions to inform its responses, ensuring that it maintains context and continuity in its interactions with users.

In some embodiments, the system includes additional functionalities to enhance the AI agent's performance. For example, the system may implement advanced scheduling algorithms to optimize the processing of events based on their priority and the current state of the AI agent. This ensures that the AI agent can handle complex interactions and multitasking scenarios efficiently, providing a seamless and responsive user experience.

In some embodiments, method 1000 is applicable in a variety of applications. For example, the task request received by a neural network model (e.g., ??) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 1000, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 1000 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based AI agent may cause an alert relating to the information technology anomaly to be displayed at a visualized user interface. In this way, IT anomalies may be detected and alerted using the neural network based artificial agent in an efficient manner so as to improve network support technology.

Embodiments herein may be applied to medical diagnostics systems. For example, an AI agent deployed in a hospital environment could asynchronously process multiple streams of patient data, such as lab results, imaging scans, and real-time vital sign monitoring. By maintaining a ledger of incoming events and prioritizing urgent alerts (e.g., a sudden drop in oxygen saturation or abnormal ECG readings), the AI agent can interrupt less critical tasks to immediately notify medical staff or trigger automated interventions. This asynchronous scheduling ensures that life-threatening conditions are addressed without delay, improving patient outcomes and enhancing the reliability of computer-assisted healthcare systems.

In software development environments, the invention enables AI-powered coding assistants to handle multiple developer requests in parallel. For instance, while generating a code snippet for one developer, the AI agent can receive and process a high-priority bug report or a request for code review from another user. The agent's ability to halt ongoing generation and reprioritize tasks based on urgency or user-defined deadlines streamlines collaborative coding sessions, reduces wait times, and increases developer productivity. This approach also allows the AI to manage tool outputs from various integrated development environments (IDEs) or code analysis tools, ensuring that the most relevant and time-sensitive information is surfaced to the user promptly.

The asynchronous scheduling framework is particularly beneficial in IT diagnostics and network management. An AI agent can monitor a network for anomalies, such as unauthorized access attempts, hardware failures, or performance bottlenecks, while simultaneously handling routine maintenance tasks. When a critical event is detected, such as a router failure or a security breach, the AI agent can immediately interrupt ongoing lower-priority processes to address the issue, notify administrators, and initiate corrective actions. This real-time, event-driven approach improves the resilience and efficiency of IT infrastructure, reduces downtime, and enhances the overall functioning of computer networks.

In robotics and industrial automation, embodiments allows AI agents to manage multiple concurrent control processes. For example, in a manufacturing plant, a robotic controller may be executing a sequence of assembly tasks while also monitoring sensor data for safety hazards or equipment malfunctions. A user may request that the robotic controller perform some action, and if a tool such as a safety sensor detects an anomaly, the AI agent can instantly halt the current operation and switch to an emergency response protocol. The ability to asynchronously process and prioritize events ensures that the robotic system can adapt to dynamic environments, maintain operational safety, and optimize throughput, thereby improving the technical performance of automated systems.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of asynchronous scheduling of output generations for an artificial intelligence (AI) agent, the method comprising:
engaging the AI agent on a computing environment to respond to one or more user task requests;
maintaining a ledger associated with the AI agent to record a sequence of events the AI agent receives from the computing environment or a user; and
asynchronously generating, by a neural network model of the AI agent, responses to the sequence of events according to priority levels associated with the sequence of events while the neural network model is in a process of generating a plurality of output tokens sequentially, including:
determining whether to halt the process of generating for a particular event based on a priority level of the particular event, and
initiating a new process of generation with the neural network model of the AI agent based on the particular event when the process of generating is halted.

2. The method of claim 1, further comprising:
training the neural network model of the AI agent on real-time type data including at least one of:
out of order messages,
time stamps,
user queries that include a requested time to finish a task, or
ignoring results of a tool request if a result is obviated based on an updated user utterance.

3. The method of claim 1, wherein the particular event is a result of a tool request from a tool of a plurality of tools.

4. The method of claim 3, wherein the priority level of the particular event is based on which tool of the plurality of tools is providing the result.

5. The method of claim 1, wherein the determining whether to halt the process of generating is further based on a current state of a state machine.

6. The method of claim 5, wherein state transitions of the state machine are based on at least one of:
an initiation of input from an input peripheral,
a completion of input from an input peripheral,
an initiation of generation with the neural network model,
a completion of generation with the neural network model,
an initiation of output to an output peripheral,
a completion of output to an output peripheral,
a tool-use request, or
a response to a tool-use request.

7. The method of claim 1, further comprising:
inputting all or a subset of the ledger to the neural network model.

8. A system for asynchronous scheduling of output generations for an artificial intelligence (AI) agent, the system comprising:
a memory that stores the AI agent and a plurality of processor executable instructions;
a communication interface that receives one or more user task requests; and
one or more hardware processors that read and execute the plurality of processor-executable instructions from the memory, wherein the plurality of processor-executable instructions are configurable to cause the system to perform operations comprising:
maintaining a ledger associated with the AI agent to record a sequence of events the AI agent receives from a computing environment or a user; and
asynchronously generating, by a neural network model of the AI agent, responses to the sequence of events according to priority levels associated with the sequence of events while the neural network model is in a process of generating a plurality of output tokens sequentially, including:
determining whether to halt the process of generating for a particular event based on a priority level of the particular event, and
initiating a new process of generation with the neural network model of the AI agent based on the particular event when the process of generating is halted.

9. The system of claim 8, wherein the plurality of processor-executable instructions are further configurable to cause the system to perform operations comprising:
training the neural network model of the AI agent on real-time type data including at least one of:
out of order messages,
time stamps,
user queries that include a requested time to finish a task, or
ignoring results of a tool request if a result is obviated based on an updated user utterance.

10. The system of claim 8, wherein the particular event is a result of a tool request from a tool of a plurality of tools.

11. The system of claim 10, wherein the priority level of the particular event is based on which tool of the plurality of tools is providing the result.

12. The system of claim 8, wherein the determining whether to halt the process of generating is further based on a current state of a state machine.

13. The system of claim 12, wherein state transitions of the state machine are based on at least one of:
an initiation of input from an input peripheral,
a completion of input from an input peripheral,
an initiation of generation with the neural network model,
a completion of generation with the neural network model,
an initiation of output to an output peripheral,
a completion of output to an output peripheral,
a tool-use request, or
a response to a tool-use request.

14. The system of claim 8, wherein the plurality of processor-executable instructions are further configurable to cause the system to perform operations comprising:
inputting all or a subset of the ledger to the neural network model.

15. A non-transitory machine-readable medium comprising a plurality of instructions, executable by one or more processors, wherein the plurality of instructions are configurable to cause the one or more processors to perform operations comprising:
maintaining a ledger associated with an AI agent to record a sequence of events the AI agent receives from a computing environment or a user; and
asynchronously generating, by a neural network model of the AI agent, responses to the sequence of events according to priority levels associated with the sequence of events while the neural network model is in a process of generating a plurality of output tokens sequentially, including:
determining whether to halt the process of generating for a particular event based on a priority level of the particular event, and
initiating a new process of generation with the neural network model of the AI agent based on the particular event when the process of generating is halted.

16. The non-transitory machine-readable medium of claim 15, wherein the plurality of instructions are further configurable to cause the one or more processors to perform operations comprising:
training the neural network model of the AI agent on real-time type data including at least one of:
out of order messages,
time stamps,
user queries that include a requested time to finish a task, or
ignoring results of a tool request if a result is obviated based on an updated user utterance.

17. The non-transitory machine-readable medium of claim 15, wherein the particular event is a result of a tool request from a tool of a plurality of tools.

18. The non-transitory machine-readable medium of claim 17, wherein the priority level of the particular event is based on which tool of the plurality of tools is providing the result.

19. The non-transitory machine-readable medium of claim 15, wherein the determining whether to halt the process of generating is further based on a current state of a state machine.

20. The non-transitory machine-readable medium of claim 19, wherein state transitions of the state machine are based on at least one of:
an initiation of input from an input peripheral,
a completion of input from an input peripheral,
an initiation of generation with the neural network model,
a completion of generation with the neural network model,
an initiation of output to an output peripheral,
a completion of output to an output peripheral,
a tool-use request, or
a response to a tool-use request.
